(19) United States
(12) Patent Application Publication
(10) Pub. No.: US 2018/0067218 A1
(43) Pub. Date: Mar. 8, 2018

(54) OBSERVATION SYSTEM AND OBSERVATION METHOD

(71) Applicant: Fujitsu Limited, Kawasaki-shi (JP)

(72) Inventors: Koji KURIHARA, Kawasaki (JP); Koichiro YAMASHITA, Hachioji (JP); Takahisa SUZUKI, Yokohama (JP)

(73) Assignee: FUJITSU LIMITED, Kawasaki-shi (JP)

(21) Appl. No.: 15/811,157

(22) Filed: Nov. 13, 2017

Related U.S. Application Data
(63) Continuation of application No. PCT/JP2015/066407, filed on Jun. 5, 2015.

(51) Int. Cl. G01V 1/22; G08C 25/00; G01V 1/04

(52) U.S. Cl. CPC G01V 1/223; G01V 1/18; G01V 1/04; G08C 25/00

(57) ABSTRACT

An observation system includes a server and a plurality of nodes. The server transmits data to the plurality of nodes and receives response data from the plurality of nodes. The server determines an incoming data-unit count and calculates a ratio of nodes that perform data transmission so that the server receives at least as many data units as a requested data-unit count to the plurality of nodes. The server sends information about the ratio to the plurality of nodes. Each of nodes transmits data to the server in accordance with the information about the ratio.

### CROSS-REFERENCE TO RELATED APPLICATION

This application is a continuation of International Application No. PCT/JP2015/066407, filed on Jun. 5, 2015, the entire contents of which are incorporated herein by reference.

### FIELD

The embodiment discussed herein is related to observation systems and the like.

### BACKGROUND

A monitoring technique, in which an observation apparatus gathers various types of environmental information using a wireless sensor network where a plurality of sensor nodes that perform wireless communication is arranged, has been proposed. Examples of the environmental information include information about temperature, humidity, soil water content, and acceleration. Hereinafter, a wireless sensor network is referred to as “WSN”.

Each sensor node of the WSN is powered by a solar battery or the like and performs measurement to obtain environmental information over a long period. This limits the amount of electric power the sensor node can use in wireless communication. For this reason, each sensor node transmits environmental information to the observation apparatus, which is distant from the sensor node, by multi-hop communication that relays the environmental information to an adjacent another sensor node rather than transmitting the environmental information directly to the observation apparatus.

Each sensor node, for which sensing interval is set in advance, of the WSN performs measurement to obtain an environmental information unit each time the sensing interval elapses and transmits the measured environmental information unit to a parent server.

Patent Document 1: Japanese Laid-open Patent Publication No. 2003-115092

Patent Document 2: Japanese Laid-open Patent Publication No. 2011-013765

Patent Document 3: Japanese Laid-open Patent Publication No. 2012-080622

However, the above-described conventional technique is disadvantageous in that shortage in the number of environmental information units transmitted from the sensor nodes to the observation apparatus can occur.

For example, the larger the number of sensor nodes included in a WSN, the more congestion between nodes is likely to occur, which can lead to a failure of environmental information units obtained by sensor nodes through measurement to reach the parent server. When the observation apparatus fails to obtain a minimum number of environmental information units, it is difficult for the observation apparatus to conduct accurate monitoring.

### SUMMARY

According to an aspect of an embodiment, an observation system includes a plurality of nodes; and a server including: a processor that executes a process including: transmitting data to the plurality of nodes; receiving, response data from the plurality of nodes; first determining an incoming data-unit count, the incoming data-unit count being the number of response data units incoming from the plurality of nodes to the server; calculating a ratio of nodes that perform data transmission so that the server receives at least as many data units as a requested data-unit count to the plurality of nodes based on a data missing ratio and the requested data-unit count, the data missing ratio being obtained from the incoming data-unit count and a total node count, the total node count being the number of the nodes included in the system; and sending information about the ratio calculated by the calculating to the plurality of nodes, wherein, each of nodes transmits data to the server in accordance with the information about the ratio.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an observation system according to an embodiment;

FIG. 2 is a sequence diagram of the observation system;

FIG. 3 is a functional block diagram illustrating a configuration of an observation apparatus;

FIG. 4 is a functional block diagram illustrating a configuration of a node;

FIG. 5 is a flowchart illustrating a procedure for processing of the observation apparatus;

FIG. 6 is a flowchart illustrating a processing procedure for profiling;

FIG. 7 is a flowchart illustrating a processing procedure for monitoring;

FIG. 8 is a flowchart illustrating a procedure for processing of a node;

FIG. 9 is a flowchart illustrating a processing procedure for cycle measurement;

FIG. 10 is a diagram illustrating a hardware configuration of a node; and

FIG. 11 is a diagram illustrating an example of a computer that executes an observation program.

### DESCRIPTION OF EMBODIMENT(S)

Preferred embodiments of the present invention will be explained with reference to accompanying drawings. The embodiment is not intended to limit the disclosure in any way.

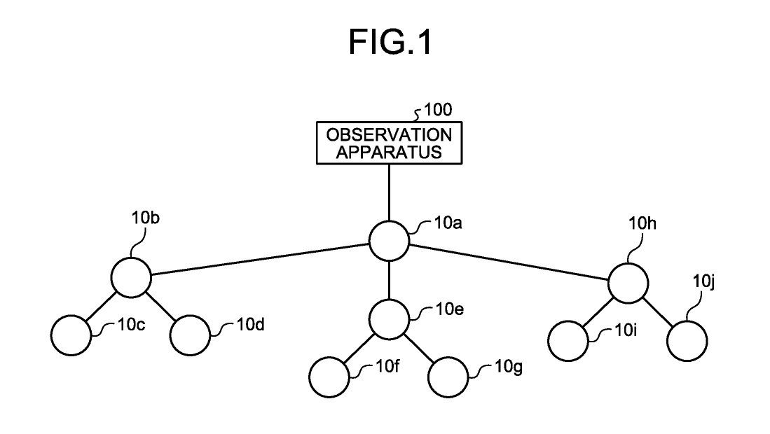

FIG. 1 is a diagram illustrating an example of an observation system according to the embodiment. As illustrated in FIG. 1, the observation system includes an observation apparatus 100 and nodes 10a, 10b, 10c, 10d, 10e, 10f, 10g, 10h, 10i, and 10j. The observation apparatus 100 is an example of “server”. Although an example where the observation system includes the nodes 10a to 10j is illustrated, the observation system may include one or more other nodes. The nodes 10a to 10j may be collectively denoted as “the nodes 10” as appropriate.

Each of the nodes 10 is charged with an energy harvester or the like and executes various processing triggered by, for instance, wireless reception or sensor response. The node 10 wirelessly transmits an environmental information unit obtained by measurement using a sensor and other information. When a battery is depleted, the node 10 is recharged to repeatedly execute processing described above. Examples of the environmental information unit include information about temperature, humidity, soil water content, and acceleration.

The node 10 transmits the environmental information unit and other information to the observation apparatus 100 via multi-hop communication. This limits the amount of electric power the node 10 can use in wireless transmission and, accordingly, makes a radio range of the node 10 short. For this reason, when distant from the observation apparatus 100, the node 10 is unable to perform direct wireless communication with the observation apparatus 100. In such a case, the node 10 transmits data to the observation apparatus 100 via multi-hop communication, in which the data is relayed via another one or more of the nodes 10.

For instance, data, which is destined for the observation apparatus 100, transmitted from the node 10j is relayed via the nodes 10h and 10a to reach the observation apparatus 100. Data, which is destined for the node 10j, transmitted from the observation apparatus 100 is relayed via the nodes 10a and 10h to reach the node 10j.

In case of occurrence of data missing due to, for instance, congestion, the node 10 performs retransmission control to transmit the data again.

The observation apparatus 100 performs profiling and monitoring. The profiling, which is to be performed by the observation apparatus 100, is described first. The observation apparatus 100 transmits a “data gathering instruction” to all the nodes 10 included in the observation system. Upon receiving the data gathering instruction, each of the nodes 10 transmits a response data unit destined for the observation apparatus 100.

The observation apparatus 100 receives response data units from the nodes 10 and determines the number of the response data units. Hereinafter, the number of the response data units is denoted as “arrived data-unit count” as appropriate. The observation apparatus 100 calculates a missing ratio from a total node count, which is the number of all the nodes 10 included in the observation system, and the arrived data-unit count. The observation apparatus 100 also calculates a measurement execution probability from the total node count, the missing ratio, and a requested data-unit count. The observation apparatus 100 informs all the nodes 10 included in the observation system of the measurement execution probability and proceeds to the monitoring, which is described below.

The requested data-unit count is a value set by an administrator in advance. When the requested data-unit count is specified, the observation apparatus 100 performs the monitoring on condition that the number of data units received from the nodes 10 be larger than or equal to the requested data-unit count. The measurement execution probability is a ratio of a minimum number of the nodes 10 that perform data transmission so that the observation apparatus 100 receives at least as many data units as the requested data-unit count to the number of all the nodes 10.

Next, the monitoring, which is to be performed by the observation apparatus 100, is described. The observation apparatus 100 transmits a “cyclical data gathering instruction” to all the nodes 10 included in the observation system. Upon receiving the cyclical data gathering instruction, each of the nodes 10 starts a cyclical operation. During the operation, the node 10 generates a random variable and, when the random variable is smaller than or equal to the measurement execution probability, the node 10 transmits an environmental information unit to the observation apparatus 100. On the other hand, when the random variable is larger than the measurement execution probability, the node 10 suspends transmission of the environmental information unit until another random variable is generated in the next cycle.

Upon receiving environmental information units of one cycle, the observation apparatus 100 compares the number of the environmental information units of one cycle against the requested data-unit count. When the number of environmental information units is larger than or equal to the requested data-unit count, the observation apparatus 100 continues processing of receiving environmental information units transmitted every cycle. On the other hand, when the number of environmental information units is smaller than the requested data-unit count, the observation apparatus 100 proceeds to the profiling.

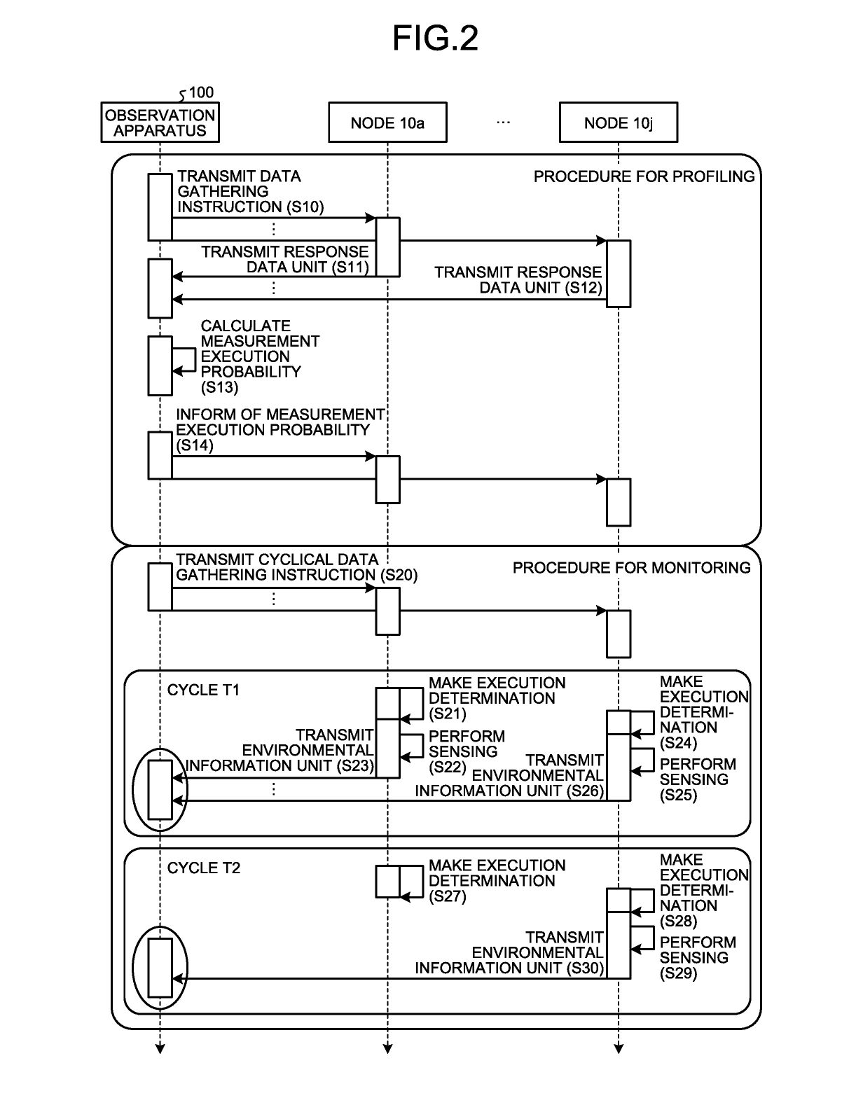

FIG. 2 is a sequence diagram of the observation system. The nodes 10a and 10j are illustrated in FIG. 2, but illustration of the other nodes 10 is omitted. A procedure for the profiling is described below. The observation apparatus 100 transmits the data gathering instruction to the nodes 10 (S10). Upon receiving the data gathering instruction, the node 10a transmits a response data unit to the observation apparatus 100 (S11). Upon receiving the data gathering instruction, the node 10j transmits a response data unit to the observation apparatus 100 (S12).

Upon receiving the response data units from the nodes 10, the observation apparatus 100 calculates a measurement execution probability (S13). The observation apparatus 100 informs the nodes 10a and 10j of the measurement execution probability (S14).

A procedure for the monitoring is described below. The observation apparatus 100 transmits a cyclical data gathering instruction to the nodes 10 (S20). Upon receiving the cyclical data gathering instruction, the nodes 10a and 10j perform an operation of a cycle T1 and an operation of a cycle T2.

The cycle T1 is described below. The node 10a makes execution determination or, specifically, generates a random variable and compares the random variable against the measurement execution probability (S21). When the random variable is smaller than or equal to the measurement execution probability, the node 10a performs sensing to acquire an environmental information unit (S22). The node 10a transmits the environmental information unit to the observation apparatus 100 (S23).

The node 10j makes execution determination or, specifically, generates a random variable and compares the random variable against the measurement execution probability (S24). When the random variable is smaller than or equal to the measurement execution probability, the node 10j performs sensing to acquire an environmental information unit (S25). The node 10j transmits the environmental information unit to the observation apparatus 100 (S26).

The cycle T2 is described below. The node 10a makes execution determination or, specifically, generates a random variable and compares the random variable against the measurement execution probability (S27). When the random variable is larger than the measurement execution probability, the node 10a is on standby until the next cycle.

The node 10j makes execution determination or, specifically, generates a random variable and compares the random variable against the measurement execution probability (S28). When the random variable is smaller than or equal to the measurement execution probability, the node 10j performs sensing to acquire an environmental information unit (S29). The node 10j transmits the environmental information unit to the observation apparatus 100 (S30).

As described above, in the observation system according to the embodiment, the observation apparatus 100 calculates a measurement execution probability using a missing ratio of data units transmitted from all the nodes 10 and informs all the nodes 10 of the measurement execution probability. Each of the nodes 10 controls transmission of an environmental information unit in accordance with the informed measurement execution probability. Hence, occurrence of a situation where all the nodes 10 simultaneously transmit environmental information units can be at least reduced. This allows obtaining as many environmental information units as the requested data-unit count or more while preventing congestion. Furthermore, because congestion is less likely to occur, data missing can be prevented, frequency of when the node 10 retransmits an environmental information unit is reduced, and reduction in power consumption can be achieved.

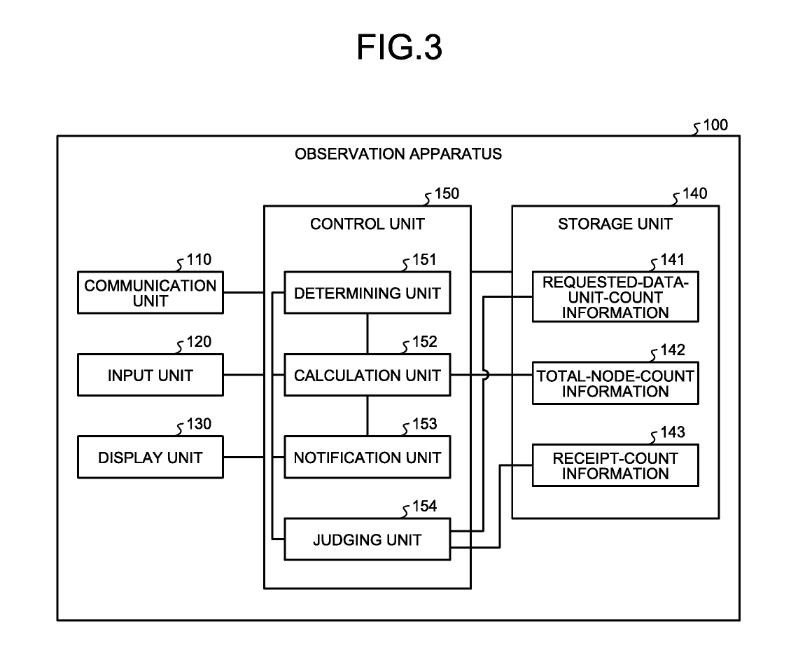

An example of a configuration of the observation apparatus 100 is described below. FIG. 3 is a functional block diagram illustrating the configuration of the observation apparatus. As illustrated in FIG. 3, the observation apparatus 100 includes a communication unit 110, an input unit 120, a display unit 130, a storage unit 140, and a control unit 150.

The communication unit 110 is a communication device that performs data communication with the nodes 10 via wireless communication. The control unit 150, which is described below, exchanges data with the nodes 10 via the communication unit 110.

The input unit 120 is an input device that inputs a variety of information to the observation apparatus 100. The input device corresponds to an input device, which may be, for instance, a keyboard, a mouse, and/or a touch panel.

The display unit 130 is a display device that displays information output from the control unit 150. The display unit 130 corresponds to, for instance, a display or a touch panel.

The storage unit 140 includes requested-data-unit-count information 141, total-node-count information 142, and receipt-count information 143. The storage unit 140 corresponds to, for instance, a storage device, such as a semiconductor memory device, examples of which include a random access memory (RAM), a read only memory (ROM), and a flash memory.

The requested-data-unit-count information 141 is information about the requested data-unit count that is set by the administrator or the like. The administrator enters the requested-data-unit-count information 141 to the observation apparatus 100 by operating the input unit 120.

The total-node-count information 142 is information about the total node count, which is the total number of nodes included in the observation system. For instance, the administrator that has acquired the total node count in advance may enter the total-node-count information 142 to the observation apparatus 100 by operating the input unit 120.

The receipt-count information 143 is information indicating a receipt count, which is the number of environmental information units received in one cycle. The receipt-count information 143 may hold cycle-by-cycle receipt counts of environmental information units.

The control unit 150 includes a determining unit 151, a calculation unit 152, a notification unit 153, and a judging unit 154. The control unit 150 may correspond to, for instance, an integrated device, such as an application specific integrated circuit (ASIC) or a field programmable gate array (FPGA). The control unit 150 may correspond to, for instance, an electronic circuit, such as a central processing unit (CPU) or a micro processing unit (MPU).

The determining unit 151 is a processing unit that determines an arrived data-unit count by transmitting the data gathering instruction to the nodes 10 of the observation system and aggregating the number of response data units transmitted from the nodes 10. The determining unit 151 outputs information about the arrived data-unit count to the calculation unit 152. The determining unit 151 determines, as the arrived data-unit count, for instance, the number of response data units received from the nodes 10 in a fixed period of time, which corresponds to one cycle, from when the data gathering instruction is transmitted.

The calculation unit 152 is a processing unit that calculates a missing ratio and a measurement execution probability. The calculation unit 152 outputs information about the measurement execution probability to the notification unit 153. Processing, through which the calculation unit 152 calculates a missing ratio, is described below. The calculation unit 152 calculates a missing ratio using Equation (1). In Equation (1), n, an arrived data-unit count, corresponds to the arrived data-unit count fed to the calculation unit 152 from the determining unit 151. N, a total node count, corresponds to the total number of nodes contained in the total-node-count information 142.

missing ratio Z=n/N (1)

Processing, through which the calculation unit 152 calculates a measurement execution probability, is described below. The calculation unit 152 calculates a measurement execution probability using Equation (2). In Equation (2), Y, a requested data-unit count, corresponds to the requested data-unit count contained in the requested-data-unit-count information 141. N, the total node count, corresponds to the total node count contained in the total-node-count information 142. Z, the missing ratio, is the missing ratio Z calculated using Equation (1). α is a margin that is set by the administrator as appropriate.

measurement execution probability P=Y/N×(1−Z)+α (2)

In Equation (2), the measurement execution probability P is a value corresponding to a ratio of a minimum number of nodes that perform data transmission so that at least as many data units as the requested data-unit count are gathered to the total node count.

The notification unit 153 is a processing unit that transmits information about the measurement execution probability to all the nodes 10 of the observation system. Upon completing transmission of the information about the measurement execution probability, the notification unit 153 outputs information indicating completion of the profiling to the judging unit 154.

Processing described above performed by the determining unit 151, the calculation unit 152, and the notification unit 153 correspond to the profiling.

Upon receiving the information indicating completion of the profiling, the judging unit 154 starts the monitoring by transmitting the cyclical data gathering instruction to all the nodes 10 of the observation system. Each time one cycle elapses, the judging unit 154 counts a receipt count of one cycle, which is the number of environmental information units received in the one cycle, and stores the receipt count in the receipt-count information 143. The judging unit 154 compares the receipt count of one cycle against the requested data-unit count and, when the number of the data units of one cycle is larger than or equal to the requested data-unit count, continues the monitoring.

On the other hand, the judging unit 154 compares the receipt count of one cycle against the requested data-unit count and, when the number of the data units of one cycle is smaller than the requested data-unit count, the judging unit 154 issues a profiling request to the determining unit 151, the calculation unit 152, and the notification unit 153 again.

Upon receiving the profiling request, the determining unit 151, the calculation unit 152, and the notification unit 153 perform the profiling again.

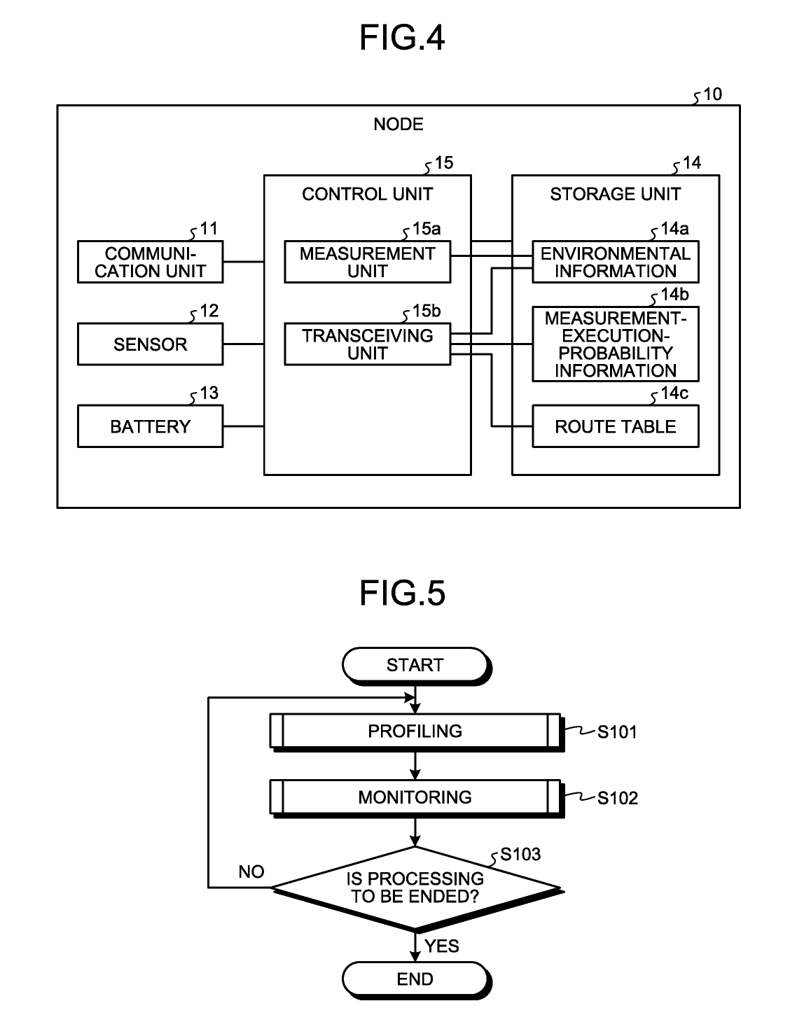

An example of a configuration of the node 10 is described below. FIG. 4 is a functional block diagram illustrating the configuration of the node. As illustrated in FIG. 4, the node 10 includes a communication unit 11, a sensor 12, a battery 13, a storage unit 14, and a control unit 15.

The communication unit 11 is a processing unit that performs data communication with another node 10 and the observation apparatus 100 via wireless communication. The control unit 15, which is described below, exchanges data with the other node 10 and the observation apparatus 100 via the communication unit 11.

The sensor 12 is a sensor that performs measurement to obtain various types of environmental information. For instance, the sensor 12 measures, as environmental information, temperature, humidity, soil water content, and acceleration.

The battery 13 is a battery to be charged using an energy harvester, such as a solar panel.

The storage unit 14 holds environmental information 14a, measurement-execution-probability information 14b, and a route table 14c. The storage unit 14 corresponds to, for instance, a storage device, such as a semiconductor memory device, examples of which include a RAM, a ROM, and a flash memory.

The environmental information 14a is environmental information obtained through measurement using the sensor 12. The measurement-execution-probability information 14b is information about the measurement execution probability informed by the observation apparatus 100. The route table 14c contains information about a route for transmitting data to a destination. For instance, the route table 14c associates a destination with an adjacent node on a way to the destination.

The control unit 15 includes a measurement unit 15a and a transceiving unit 15b. The control unit 15 may correspond to, for instance, an integrated device, such as an ASIC or an FPGA. The control unit 15 may correspond to, for instance, an electronic circuit, such as a CPU or an MPU. The control unit 15 performs an intermittent operation using a not-illustrated timer or the like in regular cycles that are set in advance. The control unit 15 may iterate a sequence, in which the control unit 15 starts the operation when a change in environmental information is detected by the sensor 12 and enters a sleep mode when a predetermined period time has elapsed since the start of the operation.

The measurement unit 15a is a processing unit that acquires the environmental information 14a from the sensor 12 and stores the acquired environmental information 14a in the storage unit 14.

Upon receiving the data gathering instruction from the observation apparatus 100, the transceiving unit 15b transmits a response data unit to the observation apparatus 100. Upon receiving the measurement-execution-probability information 14b from the observation apparatus 100, the transceiving unit 15b stores the measurement-execution-probability information 14b in the storage unit 14.

The transceiving unit 15b generates a random variable, which ranges between 0 and 1, using a random function and compares the random variable against the measurement execution probability of the measurement-execution-probability information 14b. When the random variable is smaller than or equal to the measurement execution probability, the transceiving unit 15b transmits the environmental information 14a to the observation apparatus 100. On the other hand, when the random variable is larger than the measurement execution probability, the transceiving unit 15b suspends transmission of the environmental information 14a to the observation apparatus 100.

A procedure for processing of the observation apparatus 100 according to the embodiment is described below. FIG. 5 is a flowchart illustrating the procedure for processing of the observation apparatus. As illustrated in FIG. 5, the observation apparatus 100 performs the profiling (S101). The observation apparatus 100 performs the monitoring (S102). When processing is not to be ended (No at S103), the observation apparatus 100 moves to S101. When processing is to be ended (Yes at S103), the observation apparatus 100 completes processing.

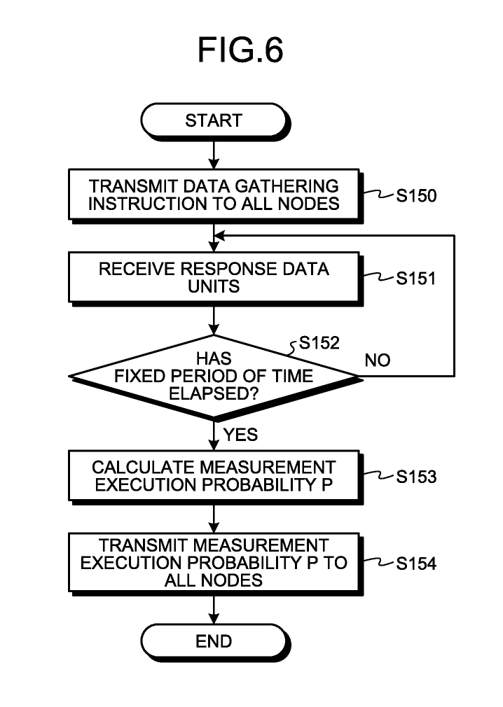

A processing procedure for the profiling illustrated in S101 of FIG. 5 is described below. FIG. 6 is a flowchart illustrating the processing procedure for the profiling. As illustrated in FIG. 6, the determining unit 151 of the observation apparatus 100 transmits the data gathering instruction to all the nodes 10 (S150) and receives response data units (S151).

The determining unit 151 determines whether the fixed period of time has elapsed (S152). When the fixed period of time has not elapsed (No at S152), the determining unit 151 moves to S151. On the other hand, when the fixed period of time has elapsed (Yes at S152), the calculation unit 152 of the observation apparatus 100 calculates a measurement execution probability (S153). The notification unit 153 of the observation apparatus 100 transmits the measurement execution probability to all the nodes 10 (S154).

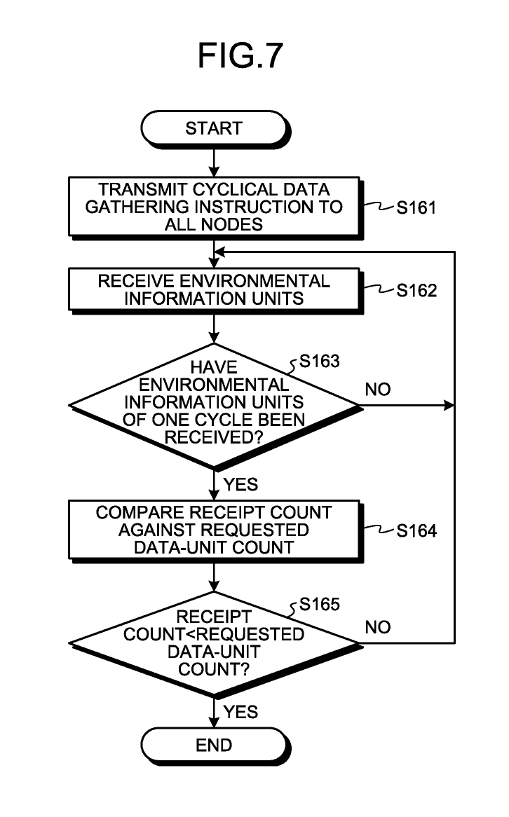

A processing procedure for the monitoring illustrated in S102 of FIG. 5 is described below. FIG. 7 is a flowchart illustrating the processing procedure for the monitoring. As illustrated in FIG. 7, the judging unit 154 of the observation apparatus 100 transmits the cyclical data gathering instruction to all the nodes 10 (S161).

The judging unit 154 receives environmental information units (S162). The judging unit 154 determines whether environmental information units of one cycle have been received (S163). When environmental information units of one cycle have not been received (No at S163), the judging unit 154 moves to S162. When environmental information units of one cycle have been received (Yes at S163), the judging unit 154 moves to S164.

The judging unit 154 compares a receipt count against the requested data-unit count (S164). When the receipt count is smaller than the requested data-unit count (Yes at S165), the judging unit 154 completes the monitoring. On the other hand, when the receipt count is not smaller than the requested data-unit count (No at S165), the judging unit 154 moves to S162.

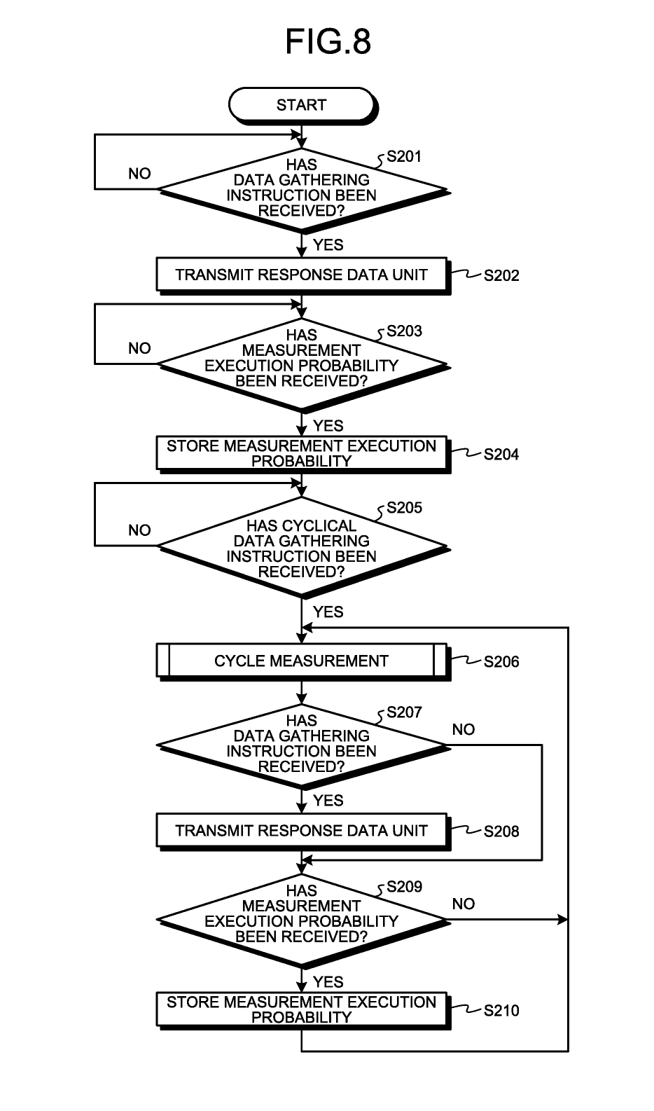

A procedure for processing of the node 10 is described below. FIG. 8 is a flowchart illustrating the procedure for processing of the node. As illustrated in FIG. 8, the node 10 determines whether the data gathering instruction has been received (S201). When the data gathering instruction has not been received (No at S201), the node 10 moves to S201 again.

When the data gathering instruction has been received (Yes at S201), the node 10 transmits a response data unit (S202). The node 10 determines whether a measurement execution probability has been received (S203). When a measurement execution probability has not been received (No at S203), the node 10 moves to S203 again.

When a measurement execution probability has been received (Yes at S203), the node 10 stores the measurement execution probability (S204). The node 10 determines whether the cyclical data gathering instruction has been received (S205). When the cyclical data gathering instruction has not been received (No at S205), the node 10 moves to S205 again.

When the cyclical data gathering instruction has been received (Yes at S205), the node 10 performs cycle measurement (S206). The node 10 determines whether the data gathering instruction has been received (S207). When the data gathering instruction has not been received (No at S207), the node 10 moves to S209.

When the data gathering instruction has been received (Yes at S207), the node 10 transmits a response data unit (S208) and moves to S209.

The node 10 determines whether a measurement execution probability has been received (S209). When a measurement execution probability has not been received (No at S209), the node 10 moves to S206. When a measurement execution probability has been received (Yes at S209), the node 10 stores the measurement execution probability (S210) and moves to S206.

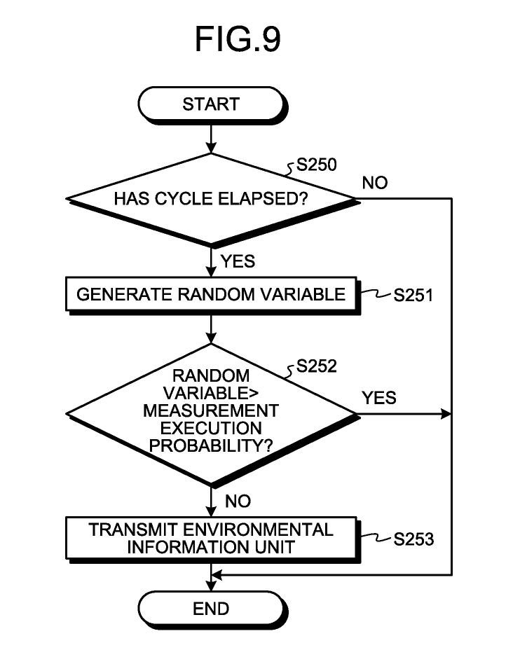

A processing procedure for the cycle measurement illustrated in S206 of FIG. 8 is described below. FIG. 9 is a flowchart illustrating the processing procedure for the cycle measurement. As illustrated in FIG. 9, the node 10 determines whether a one cycle has elapsed (S250). When a one cycle has not elapsed (No at S250), the node 10 completes the cycle measurement.

On the other hand, when a one cycle has elapsed (Yes at S250), the node 10 generates a random variable (S251). When the random variable is smaller than or equal to the measurement execution probability (No at S252), the node 10 transmits an environmental information unit (S253) and completes the cycle measurement. When the random variable is larger than the measurement execution probability (Yes at S252), the node 10 completes the cycle measurement.

Advantageous effects of the observation system according to the embodiment are described below. The observation apparatus 100 calculates a measurement execution probability using a missing ratio of response data units transmitted from all the nodes 10 and informs all the nodes 10 of the measurement execution probability. Each of the nodes 10 controls transmission of an environmental information unit in accordance with the informed measurement execution probability. Hence, occurrence of a situation where all the nodes 10 simultaneously transmit environmental information units to the observation apparatus 100 can be at least reduced. This allows obtaining as many environmental information units as the requested data-unit count or more while preventing congestion. Furthermore, because congestion is less likely to occur, data missing can be prevented, frequency of when the node 10 retransmits an environmental information unit decreases, and reduction in electric power consumed in retransmission can be achieved.

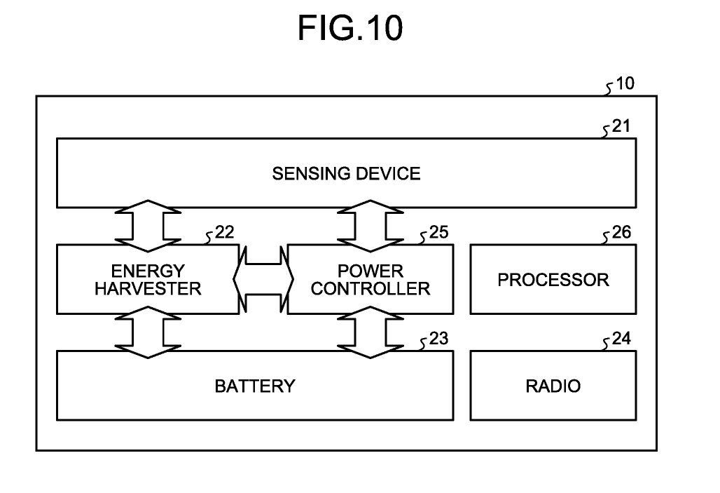

An example of a hardware configuration of the node 10 is described below. FIG. 10 is a diagram illustrating the hardware configuration of the node. The node 10 includes, for instance, a sensing device 21, an energy harvester 22, a battery 23, a radio unit 24, a power controller 25, and a processor 26.

The sensing device 21 is the sensor that performs measurement to obtain environmental information. The energy harvester 22 is a device that generates a minute amount of electricity using, for instance, ambient radio frequency or temperature. The battery 23 is a battery that accumulates the electricity generated by the energy harvester 22. The radio 24 is a device that performs data communication with another node. The power controller 25 is a device that performs power management of the node 10. The processor 26 is a device that executes processing corresponding to the control unit 15 illustrated in FIG. 4.

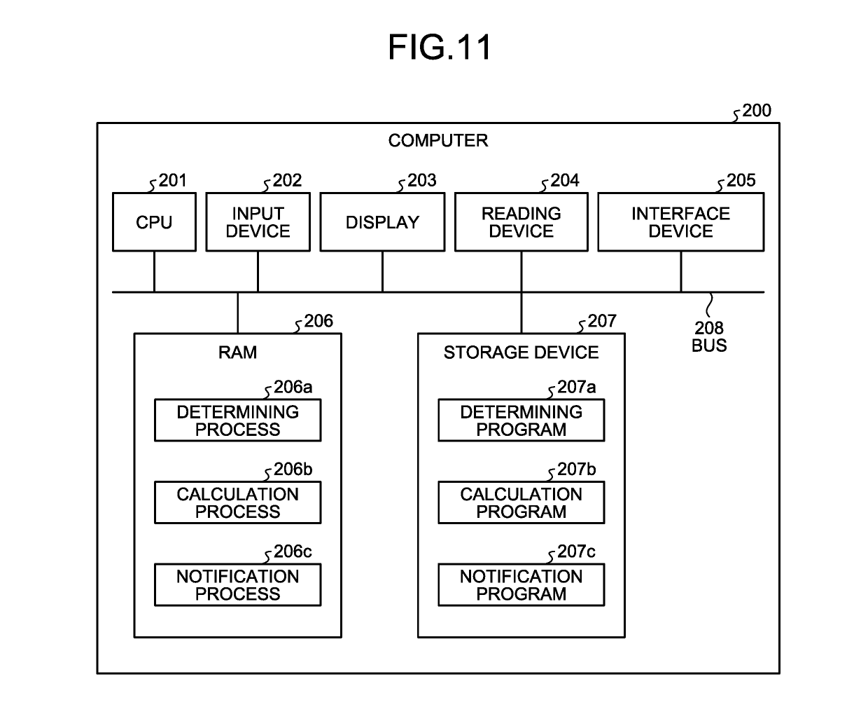

An example of a computer that executes observation program instructions (hereinafter, “program”) that implement functions similar to those of the observation apparatus 100 presented in the above-described embodiment is described below. FIG. 11 is a diagram describing an example of the computer that executes the observation program.

As illustrated in FIG. 11, a computer 200 includes a CPU 201 that executes various computing processing, an input device 202 that receives data entered by a user, and a display 203. The computer 200 further includes a reading device 204 that reads program instructions or the like from a storage medium and an interface device 205 that transmits and receives data to and from another computer via a network. The computer 200 further includes a RAM 206 that temporarily stores various types of information and a storage device 207. The devices 201 to 207 are connected to a bus 208.

The storage device 207 holds, for instance, a determining program 207a, a calculation program 207b, and a notification program 207c. The CPU 201 reads out and loads the determining program 207a, the calculation program 207b, and the notification program 207c into the RAM 206. The determining program 207a functions as a determining process 206a. The calculation program 207b functions as a calculation process 206b. The notification program 207c functions as a notification process 206c.

Processing of the determining process 206a corresponds to processing of the determining unit 151. Processing of the calculation process 206b corresponds to processing of the calculation unit 152. Processing of the notification process 206c corresponds to processing of the notification unit 153.

The determining program 207a, the calculation program 207b, and the notification program 207c are not necessarily stored in the storage device 207 in advance. For instance, the following configuration may alternatively be employed. The programs 207a to 207c are stored in advance in a “portable physical medium”, such as a flexible disk (FD), a compact disk read-only memory (CD-ROM), a digital versatile disc (DVD), a magneto-optical disk, or an integrated circuit (IC) card, to be inserted into the computer 200. The computer 200 reads out the programs 207a to 207c from the physical medium and executes the programs 207a to 207c.

According to the embodiment, occurrence of shortage in the number of environmental information units transmitted from sensor nodes to an observation apparatus can be at least reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An observation system comprising:
a plurality of nodes; and
a server comprising:
a processor that executes a process comprising:
transmitting data to the plurality of nodes;
receiving response data from the plurality of nodes;
first determining an incoming data-unit count, the incoming data-unit count being the number of response data units incoming from the plurality of nodes to the server;
calculating a ratio of nodes that perform data transmission so that the server receives at least as many data units as a requested data-unit count to the plurality of nodes based on a data missing ratio and the requested data-unit count, the data missing ratio being obtained from the incoming data-unit count and a total node count, the total node count being the number of the nodes included in the system; and
sending information about the ratio calculated by the calculating to the plurality of nodes,
wherein, each of nodes transmits data to the server in accordance with the information about the ratio.

2. The observation system according to claim 1, wherein the process further comprises second determining whether the incoming data-unit count is smaller than the requested data-unit count and the process executes the first determining, the calculating and sending again when the incoming data-unit count is smaller than the requested data-unit count.

3. The observation system according to claim 1, wherein the calculating calculates a first value obtained by subtracting the missing ratio from one, a product by multiplying the first value by the total node count and second value by dividing the requested data-unit count by the product, wherein the second value is equal to the ratio of nodes.

4. The observation system according to claim 1, wherein the each of nodes generates a random variable, compares the generated random variable against the information about the ratio, and transmits a data unit in accordance with a result of the comparison.

5. An observation method comprising:
transmitting at which a server transmits data to a plurality of nodes;
receiving at which the sever receives response data from the plurality of nodes;
determining at which the server determines an incoming data-unit count, the incoming data-unit count being the number of response data units incoming from the plurality of nodes to the server;
calculating at which the server calculates a ratio of nodes that perform data transmission so that the server receives at least as many data units as a requested data-unit count to the plurality of nodes based on a data missing ratio and the requested data-unit count, the data missing ratio being obtained from the incoming data-unit count and a total node count, the total node count being the number of the nodes included in the system;
sending at which the server sends information about the ratio calculated by the calculating to the plurality of nodes; and
transmitting at which each of nodes transmits data to the server in accordance with the information about the ratio.
